(19) United States
(12) Patent Application Publication
(10) Pub. No.: US 2005/0113173 A1
(43) Pub. Date: May 26, 2005

(54) System and method for enhancing amusement machines

(76) Inventor: David B. Waters, Piedmont, SC (US)

Correspondence Address: McNair Law Firm, P.A., P.O. Box 10827, Greenville, SC, 29603-0827, US

(21) Appl. No.: 10/941,407

(22) Filed: Sep. 15, 2004

Related U.S. Application Data
(60) Provisional application No. 60/503,020, filed on Sep. 15, 2003.

(51) Int. Cl. A63F 13/00

(52) U.S. Cl. 463/43

(57) ABSTRACT

The invention is a system for enhancing amusement games containing a game terminal, a first computer readable medium in electronic communication with the game terminal and in electronic communication with a concession terminal, player account information in communication with the first computer readable medium, and, a set of computer readable instructions in communication with the first computer readable medium. The set of instructions are for displaying an order menu during the playing of an amusement game, receiving order information from the player of an amusement game representing desired items by the player, determining whether there are sufficient credits from the player information to pay for the ordered items, debiting the player credits by an amount according to the ordered items, and providing the order information to the concession terminal so that said order can be filled.

### CROSS-REFERENCE TO RELATED APPLICATION

This application claims priority from a provisional application filed Sep. 15, 2003, Ser. No. 60/503,020, having the same title.

### FIELD OF THE INVENTION

This invention is directed to a system and method for enhancing amusement machines and more specifically for allowing a player of an amusement machine to be provided with vending services, music or other audio information, or view video information while engaging in the play of an amusement machine.

### BACKGROUND OF THE INVENTION

One objective of casinos and other gaming locations is to maximize the amount of time the player spends playing the gaming machine. Simply, the more the amusement machine is played, the more revenue can be generated for the casino. Therefore, it is advantageous to promote the amount of time a patron plays the game and equally advantageous not to cause the patron to leave the gaming machine when detracted by such tasks as ordering food or drinks. In modern casinos, the large majority of games are computer-operated and connected to a local area or wide area network. For example, the traditional mechanical “one-arm bandit” has been replaced and are now computerized games with touch screens. In the course of playing a game, a player may desire concessions or other items while playing the game. For example, a player may wish to order a hamburger, a drink, cigarettes, make hotel reservations, or even theater tickets. Traditionally, the player must leave the game, make the orders, and then return to the game. It would be advantageous to allow the player to order such concessions without having to leave the game, rather than be distracted from the game.

Further, may desire to be entertained by listening to music, audio, books, or other audio information, or even wish to watch other forms of entertainment (such as, but not limited to, video, animations, etc.). However, it is impossible for a casino to play music for the player at a sufficient volume to overcome the ambient noise of the casino, but at a comfortable volume for the casino guests. It is, therefore, advantageous to provide music to a player that can be clearly heard by the player without disturbing the surrounding guests of the casino. It would be advantageous to listen to audio through headphones so as to avoid interrupting other players' enjoyment. It would also be advantageous if the player was allowed to make song or audio information selections with minimal distraction from playing the game.

Accordingly, it is an object of this invention to provide an integrated vending system allowing a player to order concessions without leaving the amusement game.

It is another object of this invention to provide an integrated system allowing a player to listen to audio.

### SUMMARY OF THE INVENTION

The invention is a system for enhancing amusement games containing a game terminal, a first computer readable medium in electronic communication with the game terminal and in electronic communication with a concession terminal, player account information in communication with the first computer readable medium, and, a set of computer readable instructions in communication with the first computer readable medium. The set of instructions are for displaying an order menu during the playing of an amusement game, receiving order information from the player of an amusement game representing desired items by the player, determining whether there are sufficient credits from the player information to pay for the ordered items, debiting the player credits by an amount according to the ordered items, and providing the order information to the concession terminal so that said order can be filled.

The set of computer readable instructions may also include instructions for determining if a predetermined amount of time has elapsed and displaying the order menu during the playing of the game in response to the predetermined time period having elapsed. The concession station may be a dispenser for dispensing ordered products to the player of the amusement game.

The system may also include a reservation computer readable medium in communication with the first computer readable medium, and, a set of reservation computer readable instructions in communication with the reservation computer readable medium for displaying available entertainment events having reservation times, receiving a reservation request from the player of the amusement game, determining whether the reservation requested is available, providing reservation confirmation to the player if the reservation request can be made.

The set of computer readable instructions may include instructions for determining if the item ordered by the player is available, notifying the player if the item is not available, and allowing the player to alter the order. The set of computer readable instructions include instructions for prompting the player to insert additional credits if the player does not have sufficient credits to pay for the ordered item, and canceling the order of a player who does not have sufficient credits to pay for the ordered items.

A system for enhancing amusement games containing an game terminal, a first computer readable medium in communication with the amusement game, player account information in communication with the first computer readable medium having player credits, a set of media/audio information having associated genre classifications in communication with the first computer readable medium, and, a set of computer readable instructions in communication with said first computer readable medium. The set of computer readable instructions are for displaying a media/audio selection menu showing genre classification, receiving a genre selection from the player, selecting media/audio information according to the genre selection and transmitting media/audio information to the game terminal used by the player. The set of computer readable instructions can include instructions for determining if a predetermined amount of time has elapsed and displaying the media selection menu if the predetermined amount of time has elapsed. The set of computer readable instructions include instructions for determining whether there are sufficient credits from the player information to pay for the player's selection.

A system for enhancing amusement games containing a concession server in communication with a game server having player information including player credits and a concession terminal and having a computer readable medium. The game server is in communication with a game terminal. A set of computer readable instructions are embodied within the computer readable medium for receiving a concession order from a game server wherein the game server receives the concession order from the game terminal, verifying sufficient credits exist according to the player information and the concession order, sending the concession order to the concession terminal to be filled upon a determination that sufficient credits exist.

The computer readable instructions can include instructions for debiting player credits according to the concession order. The system can include game location information associated with the concession order and the computer readable instructions include instructions for transmitting the location information to the concession terminal so that the location to deliver the concessions is known. The computer readable instructions can include instructions for displaying on said game terminal, a concession menu after a predetermined period of time has elapsed.

A system for enhancing amusement games containing a reservation server in communication with a game server and having a computer readable medium wherein the game server in communication with a game terminal. A set of computer readable instructions embodied within the computer readable medium for receiving a reservation request from the game terminal, verifying the reservation request can be fulfilled and placing the reservation with the reservation server according to the reservation request.

The computer readable instructions may include instructions for displaying a reservation menu on the game terminal after a predetermined period of time has elapsed.

### DESCRIPTION OF THE DRAWINGS

FIG. 1 is a schematic of the hardware components of the system;

FIG. 2 is a flowchart detailing the operation of the invention;

FIG. 3a is the first part of a flowchart detailing the operation of the invention; and,

FIG. 3b is the second part of a flowchart detailing the operation of the invention.

### DETAILED DESCRIPTION OF THE PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated by a set of computer readable instructions embodied in a computer readable medium that is designed to perform a specific task or tasks. Actual computer or executable code or computer readable code may be contained within one file or one storage medium but may also span several computers or storage mediums. The term “host” and “server” may be hardware, software, or a combination of hardware and software that provides the functionality described herein.

The present invention is described below with reference to flowchart illustrations of methods, apparatus (“systems”) and computer program products according to the invention. It will be understood that each block, or step of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The term media is used to include audio, video, animation or any other form audio or visual information.

Certain modules, servers, computer readable media, and other aspects of the invention are in electronic communication with each other. Electronic communication can include, but is not limited to, optical communication, wired communication (including Ethernet, cable, phone line, point-to-point cables, serial communication, USB connection), wireless communication including WIFI, Bluetooth, RFD and all other forms of wireless communication, and all other known means of having computer readable media communicate with each other.

The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

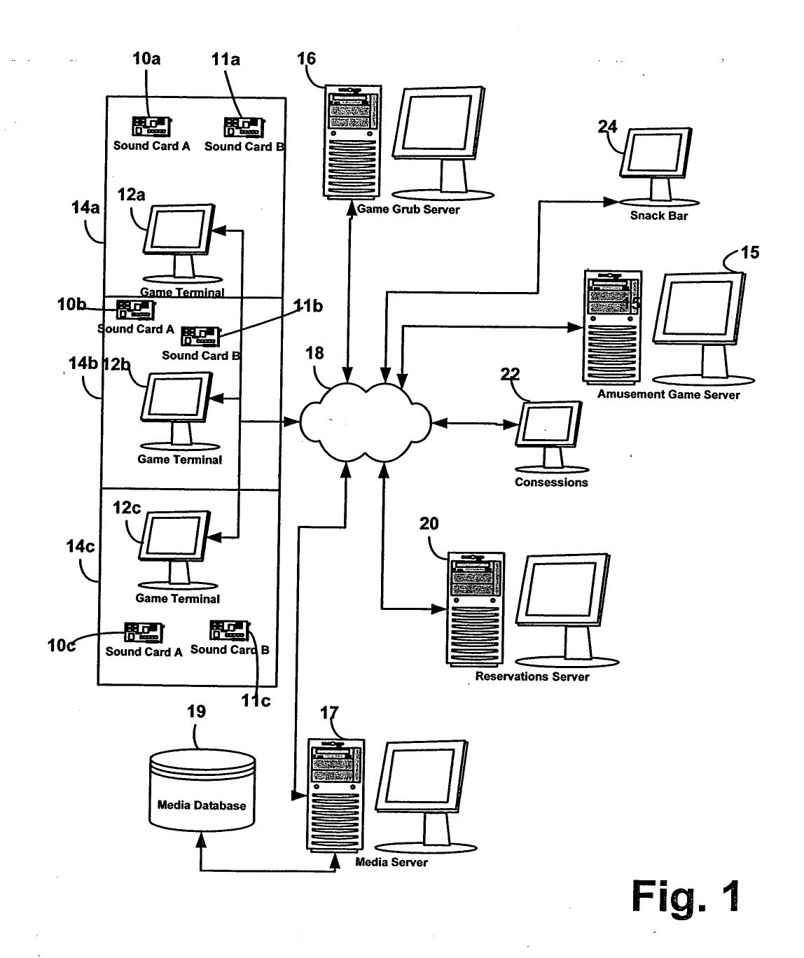

Referring now to FIG. 1, an amusement game is shown. Terminals 12a, 12b, and 12c are in communication, by network 18, to a game server 15, a game grub server 16, a media server 17, and a reservation server 20. The game terminals are individual amusement games and can include slot machines, class 11 bingo games, video games, pinball machines, or other games. The network communications allow the game terminals to share information with the servers as well as allowing the servers to share information among themselves. It should be noted that the game server, game grub server, music server, and reservation server can be physically separate servers containing the corresponding computer readable instructions, or can be software applications all contained on one or more servers. Note that the game server is the server that controls the actual play of the game, including determining winners of the game, determining prizes associated with the win, crediting player information with credits associated with the win, determining errors, and providing all functionality associated with playing an amusement game. By allowing the servers to transfer information, the advantages of this invention can be realized. Further, terminals may exist at concession stand 22 and at snack bar 24. Further, terminals can exist at waitress stations or any other location where it would be advantageous to access information located on any server.

While the player is at game terminal 12a, a screen can be displayed after a predetermined period of time and invite the player to order concessions or other items. This screen can be displayed in an overlay format or pop-up format. Computer readable instructions can display the order screen to the player and offer the player menus to order. Therefore, the player, without leaving the game, can place an order or close the screen. Alternatively, the invention can display an icon on the game screen or actuate a push button to cause the menu screen to pop up. In the event that the player decides to order food, game grub server 16 provides a concession menu including a list of food that the player can select. The food the player orders is sent as information to the concession server, the information sent to the concession server is known as order information. In one embodiment, the list of food will only include selections that are available in the concession's inventory. Additionally, the player can customize the concession order. For example, if the player orders a hamburger, he will be presented with various toppings that he may select for the burger such as ketchup, lettuce, mayonnaise, tomato, etc.

When items are selected, a concession order is created at game grub server 16 and a ticket can be printed at the game terminal memorializing the order contents. Game grub server 16 can also transmit the order information to the snack bar terminal on the concessions stand terminal so that the order can be prepared. Snack bar terminals and concession terminals are computers with associated displays that allow a user of the snack bar or concession stand terminals to review the order and prepare the order. Once the order is placed, payment can be made through player credits, from a coin or bill receiver at the game terminal, or from any other means of transmitting currency. Player credits or game credits are the amount of money the player has inserted into the machine or won while playing the machine. These credits are stored in the player information associated with the player playing the game. It is advantageous to have the order paid for prior to transmitting order information to the snack bar or concession stand to prevent a player from placing an order and leaving the casino without paying, thereby reducing the loss to the casino. By allowing the game grub server to communicate with the game server, the player credits available for ordering concessions is known and can be applied to orders from the player.

When the order is received by the game grub server from the game terminal, the game terminal location information or zone information can also be included with the order information so that the location of the player placing the order on the casino floor is known so that the order can be delivered to that location. For example, the zone information associated with the game terminal, shown as 14a in association with terminal 12a, can be added to the order information transmitted from the game terminal so that the concessions and snack bar know where to deliver the order. A printed ticket, or other display methods, provide the order information to a server and, therefore, the order can be delivered to the specific area of the casino where the player who placed the order is located.

Although a food order is used by way of example, the system is not limited to ordering food. The menu screen provided to the player can contain options including, but not limited to, the ability to order drinks, cigarettes or cigars. Generally, a player will be presented an order menu in order to determine what they wish to purchase. The order menu will appear on the display and contain a list of items available for purchase. This order menu can be a concession menu, a cigar/cigarette/drink menu, a reservation menu, a media menu, and any other type of menu which is to be presented to a player. As shown above with ordering food, the same steps are included in ordering these other items through the order menu. Once placing the order, order information is sent to the associated computer readable medium to allow the order to be filled. In one embodiment of the invention, a dispenser may be associated with the amusement gaming machine for dispensing certain items ordered including, but not limited to, cigarettes, cigars, soft drinks, and other concessions. Alternatively, orders may flow to a concession terminal where an employee will be shown the order on a display, or through a printed ticket, and fill the order by obtaining the necessary items ordered by the player and taking those items to the player. Additionally, the player can make reservations for theater shows or other entertainment, through reservations server 20. Therefore, the player can place orders, pay with existing credits and have the order delivered all while continuing to play the game. This functionality can be achieved by integrating this invention into the game software itself.

In the embodiment concerning reservations, reservation information is contained in a computer readable medium. The player is provided entertainment events and the associated reservation times. The player requests a reservation time for a specific event. If the reservation is available, the reservation time for the selected event is designated as taken and cannot be subsequently selected. Additionally, the player can receive confirmation information concerning the selected reservation.

One important aspect of attracting customers to casinos is the use of entertainment events. Entertainment events can include concerts, shows, magic shows, Broadway plays, musicals, review, sporting events, and all other types of entertainment events. A reservation menu can be included in the invention. The reservation menu operates as the general order menu operates as discussed above. After a predetermined amount of time, the reservation menu can be shown automatically to the player, or can simply be an option for the player to activate. The reservation menu contains a list of entertainment events that players may desire to attend. If a player desires to attend one of these entertainment events, by making a selection of one of the events on the reservation menu, they transmit a reservation request to an associated reservation server. Like all other orders, a reservation request is a set of data sent to the reservation server to indicate the event and the time of the event desired by the player. If tickets to this entertainment event are available, a reservation confirmation will be transmitted to the player. Note that this reservation confirmation may be an electronic confirmation sent to the player at the terminal, a printout coming from the terminal, tickets being dispensed at the terminal, or sending an individual over to the player to provide them with either a confirmation receipt, or the tickets to the entertainment event itself.

As for media information such as music, books on tape, talk radio broadcasts, video broadcasts, animations, movies, or other types of audio/visual entertainment; a media database 19 contains media that is available to the player. When a player at terminal 12a wishes to listen to audio or view media, the game terminal communicates with media server 17, which in turn communicates with media database 19 to obtain the media and provide the media to the terminal. Alternatively, media server 17 can stream media to the terminal from other sources.

The audio information can be in the form of MP3, AVI, WAV, or other such formats so that it can be transmitted electronically to the terminal from the media server. Once received by the game terminal, the selected audio information is played through a first sound card 11a. A second sound card 10a can be dedicated to the audio associated with the amusement machine and is in electronic communication with the game terminal. Therefore, the first sound card 11a is used for the selected music or other audio information. The use of two sound cards allows the player to have headphones from the first sound card without interfering with the sounds produced or associated with the amusement machine. In an alternative embodiment a single sound card can be used to produce both the player selected audio and the audio associated with the gaming machine. Although audio is used by way of example, the system is not limited to playing audio. Media that can be provided to the player can include audio books, streaming news broadcasts, talk radio, video news broadcasts, streaming or stored television broadcasts, animations, movies, or any type of audiovisual entertainment.

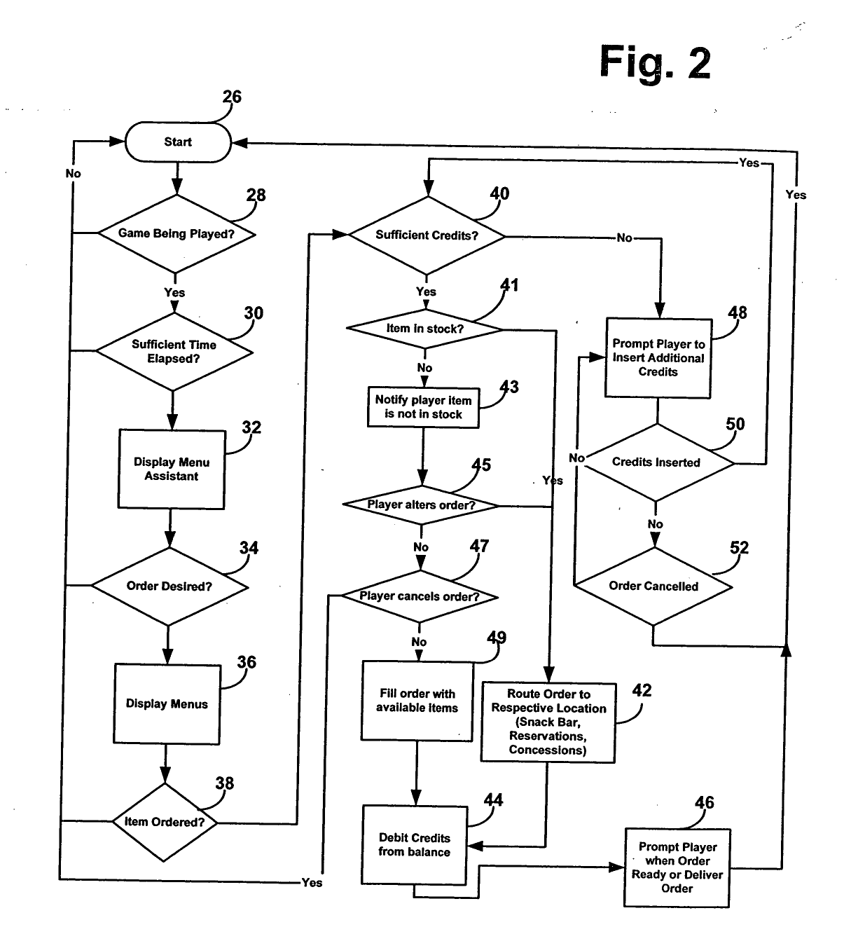

Referring now to FIG. 2, the operation of the invention is described in more detail. In step 26, the amusement game is activated. A determination is made on whether the game is actually being played in step 28. The system makes this determination through computer readable instructions that can be located on the gaming machine, or on the gaming, concession, media, or reservation server. If a game has not been begun, then the system returns to step 26. If a game is being played, a determination is made as to whether a predetermined period of time has elapsed in step 30. If the predetermined period of time has elapsed, a menu screen is shown in step 32 at the game terminal. In an alternative embodiment, the player actuates a button or selects an icon to cause the menu screen to appear. If the player decides not to order in step 34, then the system returns to step 26. If the player decides to order in step 34, further menus are displayed to the player at step 36. A determination is made as whether an order is placed in step 38. If no order was placed, the system returns to step 26. If an order is placed at step 38, then the system determines if there are a sufficient number of credits to make the order in step 40. If there are a sufficient number of credits, then the order is routed to the respective location such as the snack bar, reservations, or concessions, in step 42, and the order is paid for in step 44. In one embodiment, before the order is routed to the snack bar, concession stand or other location, a determination is made as to whether the ordered item is in inventory or in stock in step 41. If an item is not in stock, the player can be notified in step 43. Further, if an item is not in inventory, the item may not be displayed for selection to the player. The player may alter the order in step 45 and the process continues on to step 42. The player can also cancel the entire order at step 47 at which point the process returns to step 26. Otherwise, the invention can fulfill the order for those items in stock and adjust the order for items not in stock at step 49.

When the order is routed to the snack bar, concession stand or other location in step 42, the order is given to the appropriate employee to be filled. For example, a ticket containing the food order can be printed and delivered to the kitchen so that the kitchen can prepare the food. When the order is completed, the player can be prompted to pick up the order, or preferably, the order can be delivered to the player at the player's location in step 46. The system then returns to step 26. In the event that insufficient credits exist at step 40, the player is prompted to insert additional credits in step 48. The player may also insert currency to pay for the order or provide other payment means. If the player inserts additional credits at step 50, the system returns to step 40. If the player does not insert additional credits, he must cancel the order in step 52, or be prompted to insert additional credits at step 48. If the player cancels the order at step 52, then the system returns to step 26.

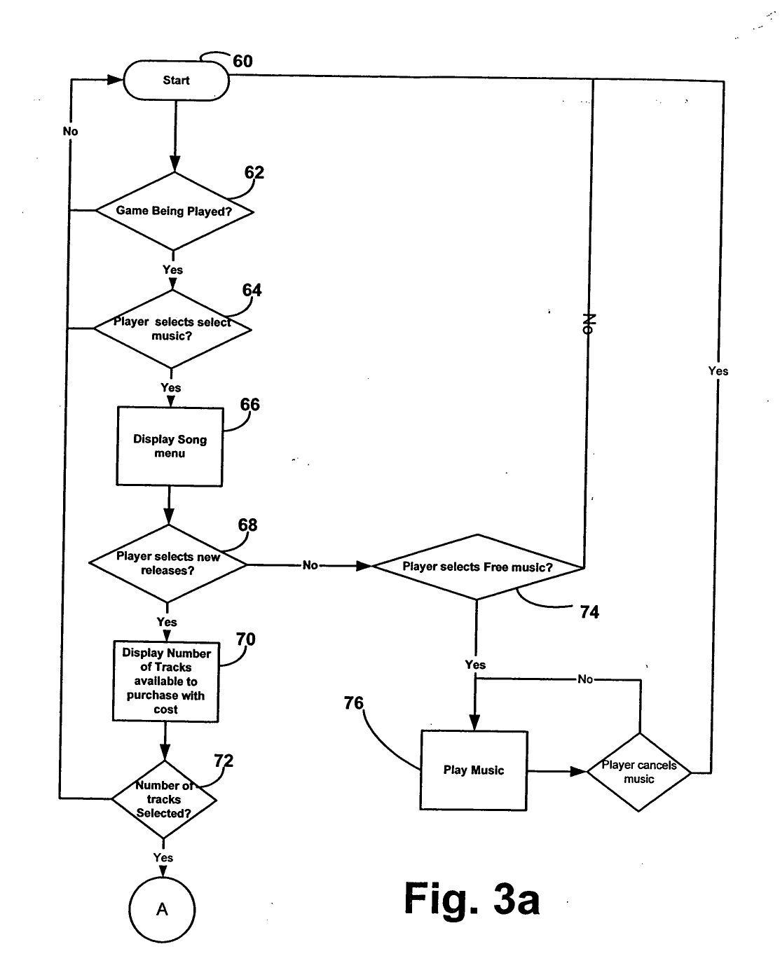

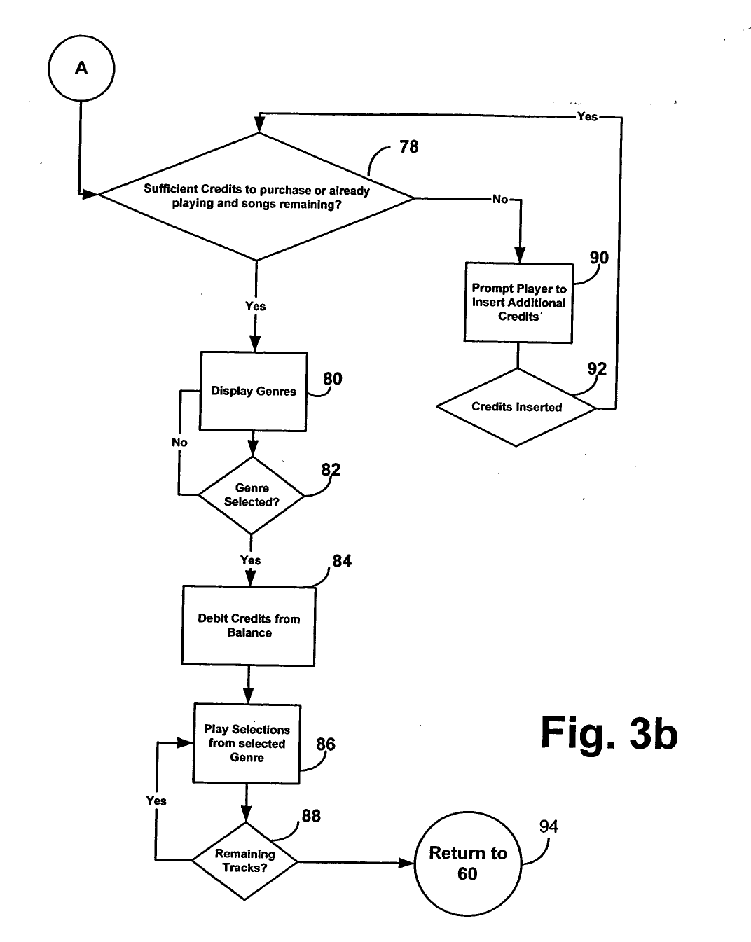

Referring now to FIG. 3a, the operation of providing audio information is described in more detail. In step 60, the system is activated. At step 62, a determination is made as to whether a game is being played. If there is no game being played at step 62, then the system returns to step 60. If there is a game in progress at step 62, then the system advances to step 64. At step 64, the player has the option to select the “select music” icon. In alternative embodiments, the player may press a button or the system may automatically display the music options screen. If the player does not select the “select music” icon at step 64, then the system returns to step 60. If the player does select the icon at step 64, then the system advances to step 66. At step 66, a media selection menu is displayed for the player. The system displays this menu through computer readable instructions that can be located on the machine, on the server or any other feasible location. In the preferred embodiment, the audio selection menu contains two options: the “new releases” option and the “free play” option. If the player chooses to select the free music option at step 74, then the system advances to step 76 where the system plays the free music. At step 68, if the player selects “new releases”, the system advances to step 70. At step 70, the screen displays options for the player to purchase a certain number of tracks from a selected genre. Genre classifications are used to separate types of audio information based on genre. The genre classifications create subsets of information within audio information. Genre classifications can include, but are not limited to, easy listening, books, rock and roll, hard rock, heavy metal, rap, R and B, jazz, funk, classical, instrumental, etc. If the player chooses one of these options at step 72, we advance to step 78 (continued on FIG. 3b). If a selection is not made at step 72, then the system returns to step 60. At step 78, the system determines if there are sufficient credits to purchase the audio selection desired or if the system is already playing a number of selections that have been purchased and there are selections remaining. For example, the player may have purchased ten tracks and begun in the easy listening genre. While listening to the third of his tracks, he wishes to switch to the classical genre. He simply clicks the new releases area and selects a new genre. The system begins playing the new genre on track four. In this example, the player is charged for the track he was currently listening to and the current track is immediately ended so that the new genre can be played. If there are not enough credits remaining at step 78 to purchase the desired number of selections, then the system advances to step 90 where the player is prompted to insert additional credits. If the player inserts additional credits, the system returns to step 78. If at step 92 the player does not insert additional credits, the system ends. If at step 78 there were sufficient credits to purchase further audio selections, then the system advances to step 80 where the available genres are displayed. From the displayed genres, the player can select a music genre such as country, rock, classical, easy listening, opera, etc. It is noted that in the preferred embodiment, only the genre can be selected rather than individual songs. By utilizing this selection process, the player spends little time making a selection and can return to playing the game, but can also listen to the type of music that is preferred. If the player does not select a genre at step 82, the system will continue to display the available genres at step 80. Once a genre of music is selected, the system advances to step 84 where the system debits sufficient credits to play the audio selection from the player's credit balance. The system then moves to step 86 where it begins to play selections from the selected genre. The selections played may be streamed through the network, they may be downloaded from the network and cached on the amusement machine itself, they may be stored constantly on the amusement machine, or they may be played, stored, or retrieved in any feasible manner known to those skilled in the art. At step 88, if the system has not played all of the purchased selections, the system returns to step 86 and continues to play selections from another unplayed selection from the selected genre until all selections of the genre are exhausted. At that point, the selections in the genre can be replayed. When selecting music from the genre, the invention can utilize a predetermined play list or can select music randomly. If at step 88 there are no more remaining selections to play, then the system at step 94 returns to step 60 on FIG. 3a.

Although audio selections are used by way of example, the system is not limited to playing audio. The media selection menu provided to the player can contain options including, but not limited to, music, audio books, streaming news broadcasts, any other type of audio that is capable of being transmitted, talk radio broadcasts, video news broadcasts, streaming or stored television broadcasts, animations, movies, or any type of audio/visual entertainment. In the case of video, the computer readable instructions cause a window to be displayed (similar to a picture in picture window on a television) that allows for the display of video. The selection of video works similarly to the selection of audio. For example, as in the audio selection, the player will be presented a menu of various types or genres of video to select from after purchasing an amount of video he cares to watch (with video, instead of selecting a number of tracks the player will select an amount of time or a number of movies or any other feasible means for selecting an amount of video to purchase). Therefore, the player can listen to or view these forms of media while continuing to play the game since this invention can be integrated into the game itself.

1. A system for enhancing amusement games comprising:
a game terminal;
a first computer readable medium in electronic communication with said game terminal and in electronic communication with a concession terminal;
player account information in communication with said first computer readable medium; and,
a set of computer readable instructions in communication with said first computer readable medium for displaying an order menu during the playing of an amusement game, receiving order information from the player of an amusement game representing desired items by the player, determining whether there are sufficient credits from said player information to pay for said ordered items, debiting said player credits by an amount according to said ordered items, and providing said order information to said concession terminal so that said order can be filled.

2. The system of claim 1 wherein said set of computer readable instructions include instructions for determining if a predetermined amount of time has elapsed and displaying said order menu during the playing of the game in response to said predetermined time period having elapsed.

3. The system of claim 1 wherein said concession station is a dispenser for dispensing ordered products to the player of said game terminal.

4. The system of claim 1 further comprising:
a reservation computer readable medium in communication with said first computer readable medium; and,
a set of reservation computer readable instructions in communication with said reservation computer readable medium for displaying available entertainment events having reservation times, receiving a reservation request from the player of the amusement game, determining whether said reservation requested is available, providing reservation confirmation to the player if the reservation request can be made.

5. The system of claim 1 wherein said set of computer readable instructions include instructions for determining if the item ordered by the player is available, notifying the player if the item is not available, and allowing the player to alter the order.

6. The system of claim 1 wherein said set of computer readable instructions include instructions for prompting the player to insert additional credits if the player does not have sufficient credits to pay for the ordered item, and canceling the order of a player who does not have sufficient credits to pay for the ordered items.

7. A system for enhancing amusement games comprising:
a game terminal;
a first computer readable medium in communication with said amusement game;
player account information in communication with said first computer readable medium having player credits; and,
a set of audio information having associated genre classifications in communication with said first computer readable medium; and,
a set of computer readable instructions in communication with said first computer readable medium for displaying a media selection menu showing genre classification, receiving a genre selection from the player, selecting audio information according to said genre selection and transmitting said audio information to the game terminal used by the player.

8. The system of claim 7 wherein said set of computer readable instructions include instructions for determining if a predetermined amount of time has elapsed and displaying said media selection menu if the predetermined amount of time has elapsed.

9. The system of claim 7 wherein said set of computer readable instructions include instructions for determining whether there are sufficient credits from said player information to pay for the player's selection.

10. The system of claim 7 further comprising a sound card associated with said first computer readable medium for providing said media information to the player.

11. A system for enhancing amusement games comprising:
a concession server in communication with a game server having player information including player credits and a concession terminal, said game server having a computer readable medium;
said game server in communication with a game terminal; and,
a set of computer readable instructions embodied within said computer readable medium for receiving a concession order from said game server wherein said game server receives said concession order from said game terminal, verifying sufficient credits exist according to said player information and said concession order, sending said concession order to said concession terminal to be filled upon a determination that sufficient credits exist.

12. The system of claim 11 wherein said computer readable instructions include instructions for debiting said player credits according to said concession order.

13. The system of claim 11 including:
game location information associated with said concession order; and,
said computer readable instructions include instructions for transmitting said game location information to said concession terminal so that the location to deliver the concessions is known.

14. The system of claim 11 wherein said computer readable instructions include instructions for displaying a concession menu on said game terminal after a predetermined period of time has elapsed.

15. The system of claim 11 wherein said computer readable instructions include instructions for determining whether a concession item is available for order, notifying a player if the item is not available and allowing the player to modify the order accordingly.

16. A system for enhancing amusement games comprising:
a reservation server in communication with a game server and having a computer readable medium, said game server in communication with a game terminal; and,
a set of computer readable instructions embodied within said computer readable medium for receiving a reservation request from said game terminal, verifying said reservation request can be fulfilled and placing said reservation with said reservation server according to said reservation request.

17. The system of claim 16 wherein said computer readable instructions include instructions for displaying on said game terminal, a reservation menu after a predetermined period of time has elapsed.

18. A system for enhancing amusement games comprising:
a media server in communication with a game server having player information including player credits and having a computer readable medium;
said game server in communication with a game terminal; and,
a set of computer readable instructions embodied within said computer readable medium for receiving a media order from said game server wherein said game server receives said media order from said game terminal, verifying sufficient credits exist according to said player information and said media order, and transmitting media information to said game server to be performed at said game terminal if sufficient player credits exist.

19. The system of claim 18 wherein said computer readable instructions include instructions for displaying on said game terminal a media menu after a predetermined period of time has elapsed.
